(19) United States
(12) Patent Application Publication
(10) Pub. No.: US 2016/0248302 A1
(43) Pub. Date: Aug. 25, 2016

(54) DRIVE UNIT, METHOD FOR REMOVING INVERTER, AND METHOD FOR INSTALLING INVERTER

(71) Applicant: KABUSHIKI KAISHA YASKAWA DENKI, Kitakyushu-shi (JP)

(72) Inventors: Toshio NAGAO, Kitakyushu-shi (JP); Kazuo MIURA, Kitakyushu-shi (JP); Tetsuya ITO, Kitakyushu-shi (JP)

(73) Assignee: KABUSHIKI KAISHA YASKAWA DENKI, Kitakyushu-shi (JP)

(21) Appl. No.: 15/019,971

(22) Filed: Feb. 10, 2016

(30) Foreign Application Priority Data
Feb. 20, 2015 (JP) 2015-032038

(51) Int. Cl. H02K 9/19; H02K 15/00; H02K 11/33

(52) U.S. Cl. CPC H02K 9/19; H02K 11/33; H02K 15/0006

(57) ABSTRACT

A drive unit includes: an electric motor; a circuit case that houses an inverter therein and is installed on the electric motor; a first cooling flow passage that is provided, in contact with the inverter, in the circuit case and lets a cooling liquid flow therethrough; a second cooling flow passage that is provided in the electric motor and lets the cooling liquid flow therethrough in communication with the first cooling flow passage; and an open end that is provided on at least one end side of the first cooling flow passage so as to be capable of being opened to the outside of the flow passage for the cooling liquid when the circuit case is installed on the electric motor.

### CROSS-REFERENCE TO RELATED APPLICATION

This application claims priority from Japanese Patent Application No. 2015-032038 filed with the Japan Patent Office on Feb. 20, 2015, the entire content of which is hereby incorporated by reference.

### BACKGROUND

1. Technical Field

The present disclosure relates to a drive unit, a method for removing an inverter, and a method for installing an inverter.

2. Description of the Related Art

JP-A-2011-182480 discloses an integrated power conversion apparatus and rotating electrical machine.

### SUMMARY

A drive unit includes: an electric motor; a circuit case that houses an inverter therein and is installed on the electric motor; a first cooling flow passage that is provided, in contact with the inverter, in the circuit case and lets a cooling liquid flow therethrough; a second cooling flow passage that is provided in the electric motor and lets the cooling liquid flow therethrough in communication with the first cooling flow passage; and an open end that is provided on at least one end side of the first cooling flow passage so as to be capable of being opened to the outside of the flow passage for the cooling liquid when the circuit case is installed on the electric motor.

### BRIEF DESCRIPTION OF THE DRAWINGS

FIG. 1 is a schematic view of a transport machine;

FIG. 2 is a perspective view of a drive unit;

FIG. 3 is a perspective view of the drive unit seen from a direction different from that in FIG. 2;

FIG. 4 is a cross-sectional view of the drive unit taken along line IV-IV in FIG. 2;

FIG. 5 is a cross-sectional view of the drive unit taken along line V-V in FIG. 2;

FIG. 6 is a perspective view illustrating the state in which a circuit case is separated from an electric motor;

FIG. 7 is a perspective view of the drive unit seen from a direction different from that in FIG. 6;

FIG. 8 is a perspective view of the drive unit without illustration of the circuit case in FIG. 2;

FIG. 9 is a perspective view of the drive unit without illustration of the circuit case in FIG. 3;

FIG. 10 is a perspective view of an internal structure of a circuit case body;

FIG. 11 is a cross-sectional view of the drive unit taken along line XI-XI in FIG. 4;

FIG. 12 is a cross-sectional view of the drive unit taken along line XII-XII in FIG. 4;

FIG. 13 is a diagram illustrating an inverter removal procedure;

FIG. 14 is a diagram illustrating the inverter removal procedure;

FIG. 15 is a diagram illustrating the inverter removal procedure;

FIG. 16 is a diagram illustrating the inverter removal procedure; and

FIG. 17 is a diagram illustrating the inverter removal procedure.

### DESCRIPTION OF THE EMBODIMENTS

In the following detailed description, for purpose of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

A drive unit according to one embodiment of the present disclosure includes: an electric motor; a circuit case that houses an inverter therein and is installed on the electric motor; a first cooling flow passage that is provided, in contact with the inverter, in the circuit case and lets a cooling liquid flow therethrough; a second cooling flow passage that is provided in the electric motor and lets the cooling liquid flow therethrough in communication with the first cooling flow passage; and an open end that is provided on at least one end side of the first cooling flow passage so as to be capable of being opened to the outside of the flow passage for the cooling liquid when the circuit case is installed on the electric motor.

A method for removing an inverter according to one embodiment of the present disclosure, includes: (A) in a drive unit including an electric motor fixed to a transport machine and a circuit case that houses an inverter and is installed on the electric motor from above, discharging a cooling liquid from a cooling flow passage provided, in contact with the inverter, in the circuit case; (B) after the discharging (A) of the cooling liquid, removing an electric system in the inverter; and (C) after the removing (B) of the electric system, removing the circuit case from the electric motor.

A method for installing an inverter according to one embodiment of the present disclosure, includes: (a) installing a circuit case housing an inverter to an electric motor fixed to a transport machine; (b) after the installing (a) of the circuit case, connecting an electric system to the inverter; and (c) after the connecting (b) of the electric system, passing a cooling liquid through a cooling flow passage provided, in contact with the inverter, in the circuit case.

According to an embodiment of the present disclosure, the inverter can be easily replaced.

Embodiment of the present disclosure will be described below in detail with reference to the drawings. In the following description, identical elements or elements having identical functions will be given identical reference signs, and duplicated descriptions thereof will be omitted.

### [Drive Unit]

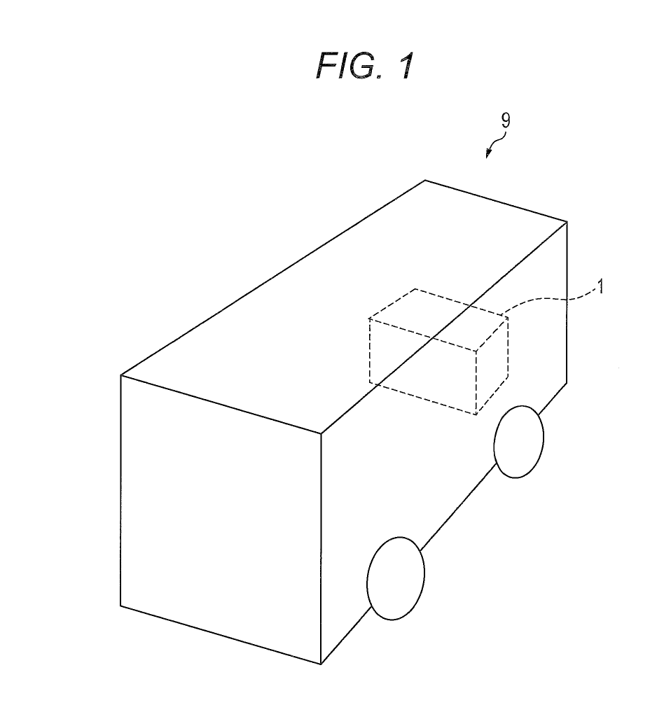

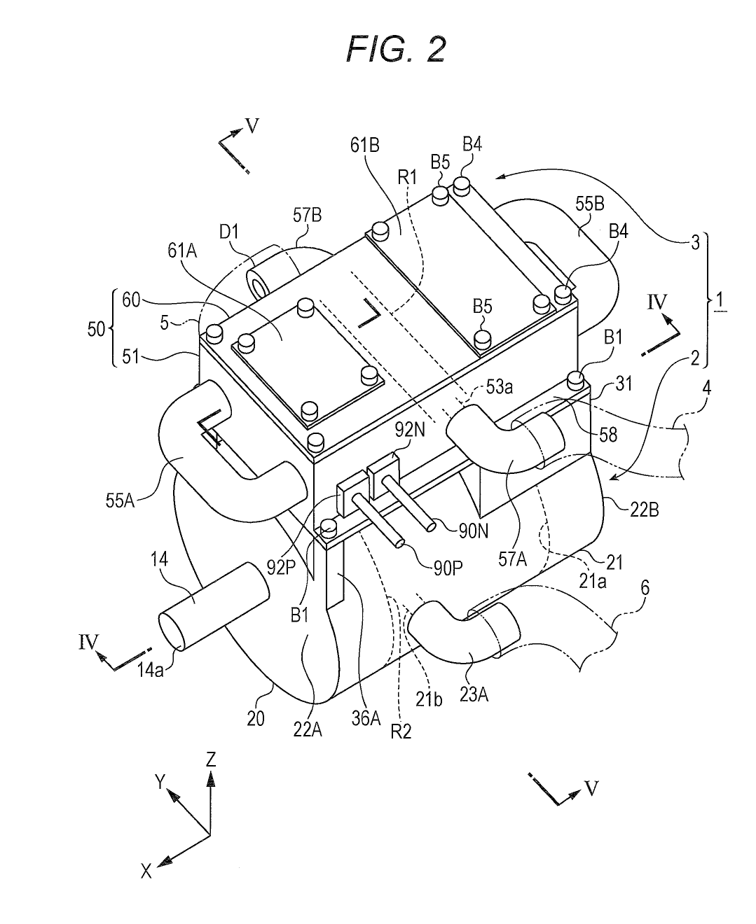

As illustrated in FIG. 1, a drive unit 1 is mounted as a power source in a transport machine 9 such as an automobile or a railway vehicle. In the following description, the term “upper and lower sides” refers to the upper and lower sides of the drive unit 1 mounted in a transport machine 9. As illustrated in FIGS. 2 to 4, the drive unit 1 includes an electric motor 2 and an inverter unit 3.

### (Electric Motor)

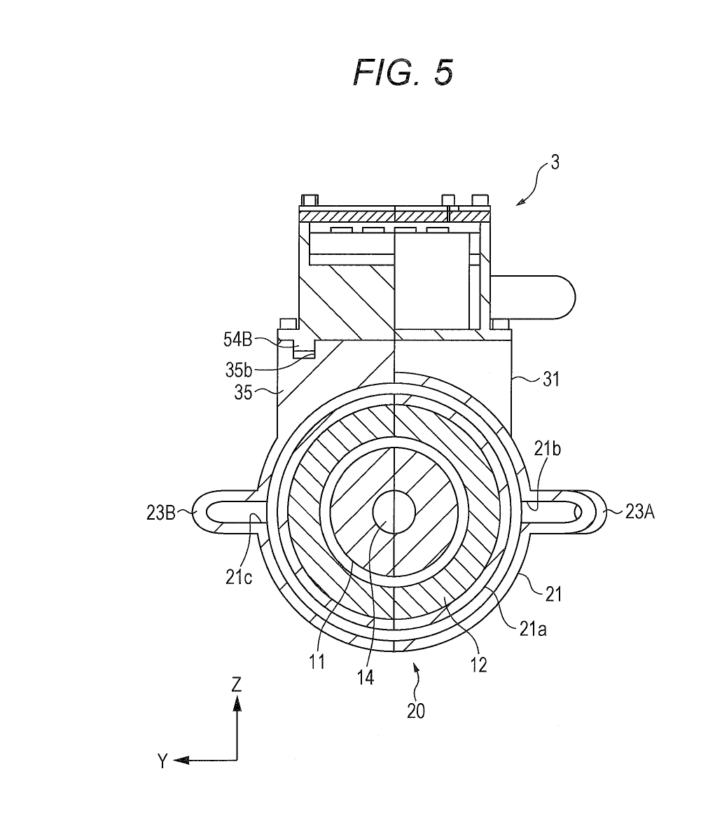

The electric motor 2 is a synchronous-type or an induction-type three-phase AC motor, for example. The electric motor 2 has a rotor 11, a stator 12, a rotation detector 13, and a motor case 20. The rotor 11 includes a shaft 14 and a field magnet (not illustrated) such as a permanent magnet. The stator 12 surrounds the rotor 11 (see FIG. 5). The stator 12 includes an armature winding, for example, and generates a rotating magnetic field with supply of three-phase AC power. The rotation detector 13 is a resolver, for example, and detects the rotation angle of the rotor 11.

The motor case 20 houses the rotor 11 and the stator 12, and is fixed in the transport machine 9. The motor case 20 has a cylindrical body 21 and end walls 22A and 22B closing both ends of the cylindrical body 21. The motor case 20 houses the rotor 11 and the stator 12 inside the cylindrical body 21. The shaft 14 of the rotor 11 is rotatably held by the end walls 22A and 22B. The stator 12 is fixed to the inner periphery surface of the cylindrical body 21. The shaft 14 has one end (hereinafter, referred to as “output end”) 14a penetrating through the end wall 22A and extending to the outside of the motor case 20.

In the following description, the direction along the shaft 14 will be called “longitudinal direction of the electric motor 2.” The direction orthogonal to the vertical direction and the longitudinal direction will be called “width direction of the electric motor 2.” The term “upper and lower sides” refers to the upper and lower sides in the vertical direction. The simple expression “lateral direction” includes “all directions crossing the vertical direction.” Note that the ±Z direction indicated in the figures shows an up-and-down direction (vertical direction). The ±X direction shows the direction along the shaft 14, that is, the longitudinal direction of the electric motor 2. The ±Y direction shows the width direction of the electric motor 2.

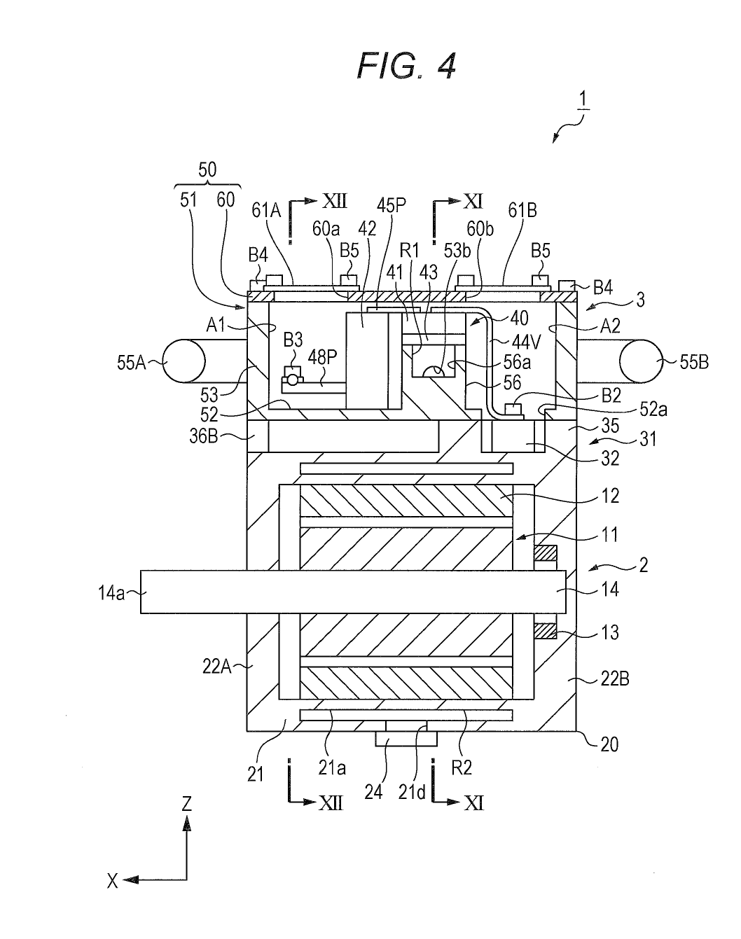

The cylindrical body 21 has therein an annular cavity 21a surrounding the stator 12 (see FIG. 5). The cylindrical body 21 has drain hole 21d in the lower part (see FIG. 4). The drain hole 21d communicates with the cavity 21a and opens to the outside. The drain hole 21d is filled by a screwed drain plug 24, for example.

As illustrated in FIG. 5, the cylindrical body 21 has side holes 21b and 21c formed in the side portions. The side holes 21b and 21c communicate with the cavity 21a and open to the outside. The side holes 21b and 21c are opposite to each other on the periphery of the cylindrical body 21. The side hole 21b, the cavity 21a, and the side hole 21c are included in a series of flow passage R2.

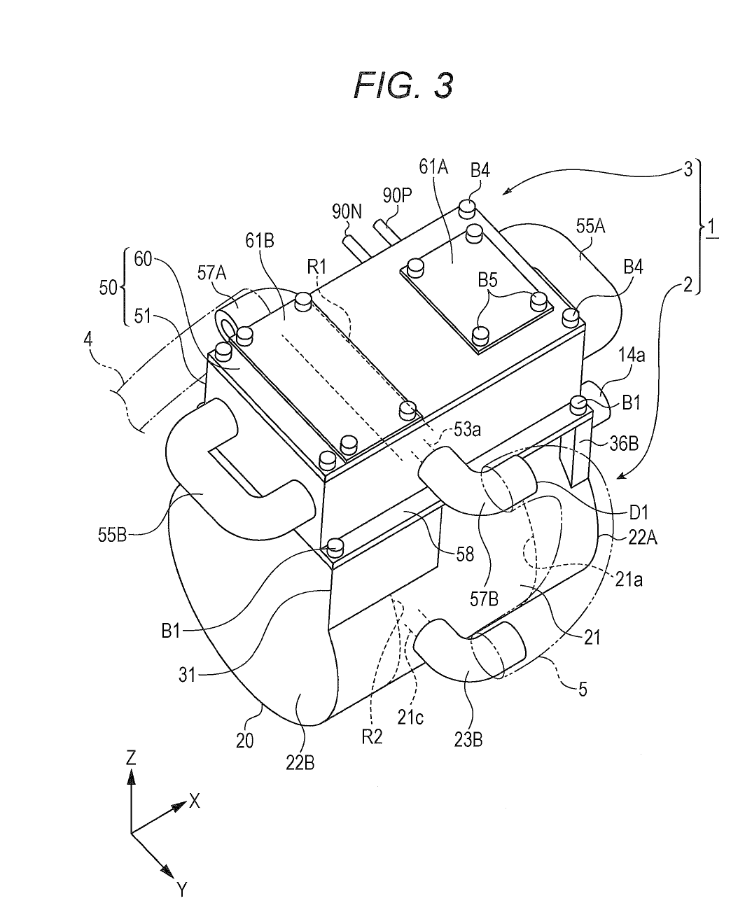

As illustrated in FIGS. 2 and 3, joint pipes 23A and 23B are provided at periphery edges of the side holes 21b and 21c, respectively. The joint pipes 23A and 23B protrude outward from the outer periphery surface of the cylindrical body 21. The joint pipes 23A and 23B bend in the middle toward the cylindrical body 21. The tips of the joint pipes 23A and 23B open in the direction along the outer periphery surface of the cylindrical body 21. That is, the drive unit 1 further includes the pair of joint pipes 23A and 23B connected to respective both ends of the flow passage R1.

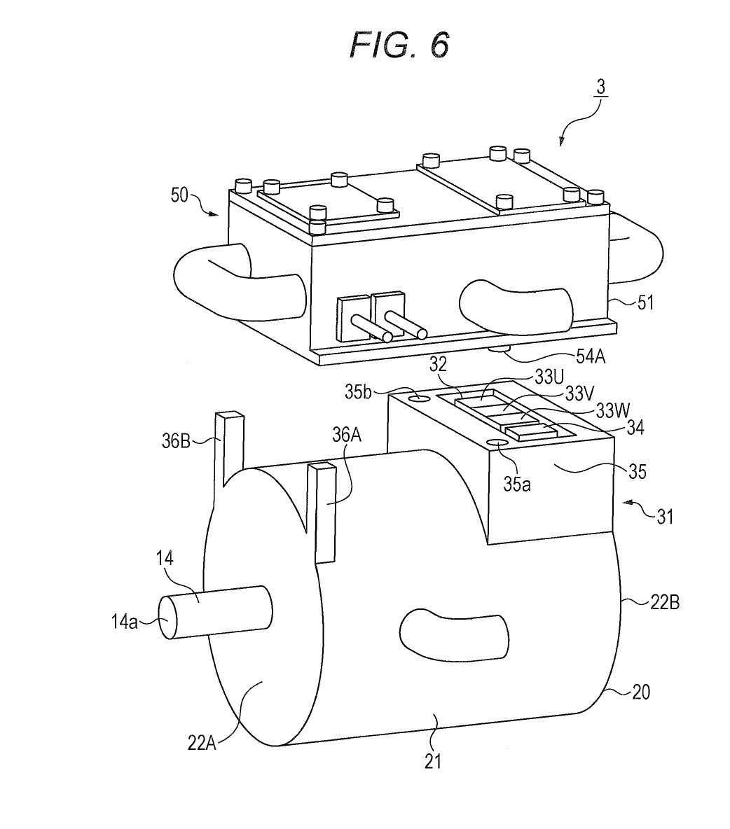

As illustrated in FIG. 6, a connecting portion 31 and columns 36A and 36B are provided on the upper part of the cylindrical body 21. The connecting portion 31 is positioned on the upper part of the cylindrical body 21 at the side distant from the output terminal 14a. The columns 36A and 36B are positioned on the upper part of the cylindrical body 21 at the side near the output terminal 14a.

The connecting portion 31 has a power supply terminal 32, a signal connector 34, and a peripheral wall 35. The power supply terminal 32 and the signal connector 34 are aligned along the width direction of the electric motor 2. The power supply terminal 32 has input terminals 33U, 33V, and 33W corresponding to three-phase AC power. The input terminals 33U, 33V, and 33W are connected to the winding of the stator 12 and aligned along the width direction of the electric motor 2. The signal connector 34 is connected to the rotation detector 13 (see FIG. 4). The peripheral wall 35 protrudes upward from the outer periphery surface of the cylindrical body 21 and surrounds the power supply terminal 32 and the signal connector 34. The peripheral wall 35 has upwardly opened positioning holes 35a and 35b in the upper surface.

The columns 36A and 36B are aligned along the width direction of the electric motor 2 and protrude upward.

The peripheral wall 35 and the columns 36A and 36B support a circuit case 50 (described later) of the inverter unit 3 in conjunction with each other. The positioning holes 35a and 35b serve as attachment portions for positioning the circuit case 50. That is, the drive unit 1 further includes the positioning holes 35a and 35b as an example of the first attachment portion provided in the upper part of the electric motor 2.

The foregoing configuration of the electric motor 2 is a mere example and the configuration of the electric motor 2 is not limited to this. For example, the field magnet may be provided at the stator 12 side and the armature winding at the rotor 11 side.

### (Inverter Unit)

As illustrated in FIGS. 4, 8, and 9, the inverter unit 3 has an inverter 40 and the circuit case 50. The inverter 40 has a circuit board 41, a smoothing capacitor 42, a heat sink 43, output terminals 44U, 44V, and 44W, relay conductors 45P and 45N, a signal cable 46, and input terminals 48P and 48N.

The circuit board 41 includes a switching circuit for power conversion and a control circuit for controlling the switching circuit. The switching circuit and the control circuit may be mounted on the same substrate or may be mounted on separate substrates. The circuit board 41 converts DC power into three-phase AC power at a desired frequency and supplies the three-phase AC power to the electric motor 2. The smoothing capacitor 42 smooths out an input voltage from a DC power source. The heat sink 43 is stacked on the circuit board 41 and absorbs heat generated by the switching elements and others on the circuit board 41 to discharge the same to the outside.

The output terminals 44U, 44V, and 44W extend from the circuit board 41 and output the three-phase AC power generated by the circuit board 41. The output terminals 44U, 44V, and 44W are connected to the input terminals 33U, 33V, and 33W, respectively. The relay conductors 45P and 45N connect the circuit board 41 with the smoothing capacitor 42 to guide DC power to the circuit board 41. The signal cable 46 extends from the circuit board 41. The signal cable 46 transmits an output signal from the rotation detector 13 to the control circuit on the circuit board 41. A signal connector 47 is provided at the tip of the signal cable 46. The signal connector 47 is connected to the signal connector 34. The input terminals 48P and 48N jut from the smoothing capacitor 42. A terminal 91P of a power cable 90P and a terminal 91N of a power cable 90N are connected to the input terminals 48P and 48N, respectively.

As illustrated in FIGS. 2 to 4, the circuit case 50 houses the inverter 40 and is installed on the electric motor 2 from above. The circuit case 50 has a case body 51 and a top plate 60.

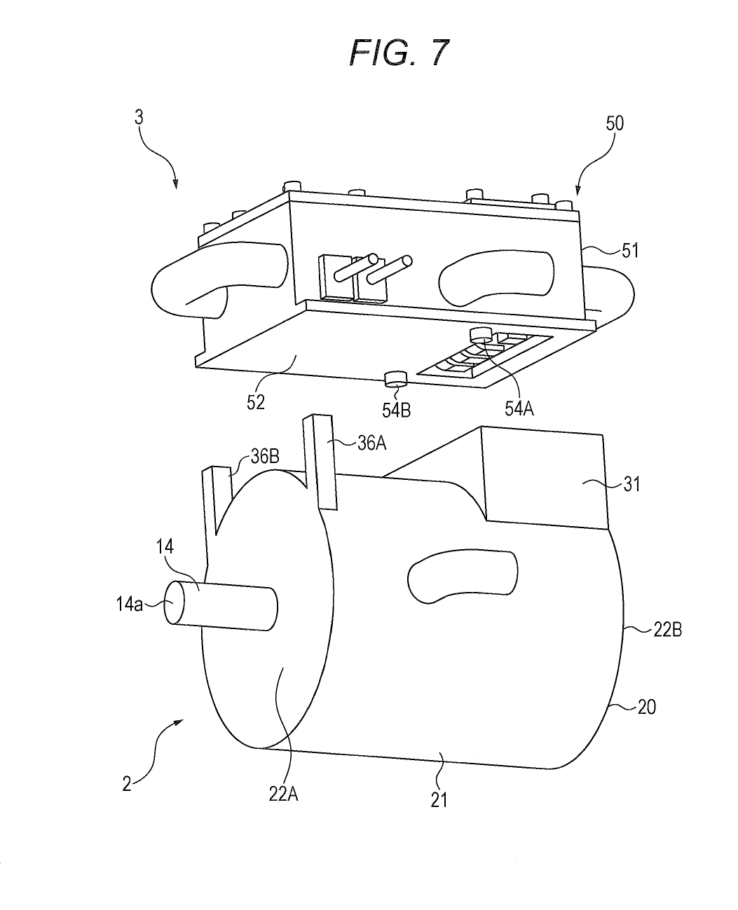

The case body 51 has an upwardly opened peripheral wall 53 and a bottom portion 52 closing the bottom of the case body 51. The bottom portion 52 and the peripheral wall 53 are rectangular-shaped in planar view. However, the bottom portion 52 and the peripheral wall 53 may not be necessarily so shaped. Positioning protrusions 54A and 54B are provided on the lower surface of the bottom portion 52 (see FIGS. 6 and 7).

The positioning protrusions 54A and 54B are attached to (e.g. fit into or inserted into) the positioning holes 35a and 35b in the upper part of the electric motor 2 from above, respectively. That is, the drive unit 1 further includes the positioning protrusions 54A and 54B as an example of a second attachment portion that is provided on the lower part of the circuit case 50 and attached to the first attachment portion from above. The attachment of the positioning protrusions 54A and 54B to the positioning holes 35a and 35b allows the circuit case 50 to be easily positioned relative to the electric motor 2. At that time, a pair of parallel surfaces constituting the outer periphery surface of the peripheral wall 53 aligns with the longitudinal direction of the electric motor 2. The other pair of parallel surfaces constituting the outer periphery surface of the peripheral wall 53 aligns with the width direction of the electric motor 2.

An installation margin 58 jutting to the lateral direction (for example, the width direction of the electric motor 2) is formed at the lower part of the circuit case 50. When the positioning protrusions 54A and 54B are attached to the positioning holes 35a and 35b, the installation margin 58 is positioned on the peripheral wall 35 and the columns 36A and 36B. The installation margin 58 is fastened by bolts B1 from above to the peripheral wall 35 and the columns 36A and 36B. That is, the drive unit 1 further includes the bolts B1 as an example of a member for fastening the circuit case 50 to the electric motor 2 from above.

Grip handles 55A and 55B are provided at the outside of the case body 51. The handles 55A and 55B jut outward from the pair of parallel surfaces along the width direction of the electric motor 2 on the outer periphery surface of the peripheral wall 53, for example. The handles 55A and 55B can be used for carrying the case body 51 at the time of installation onto or removal from the electric motor 2.

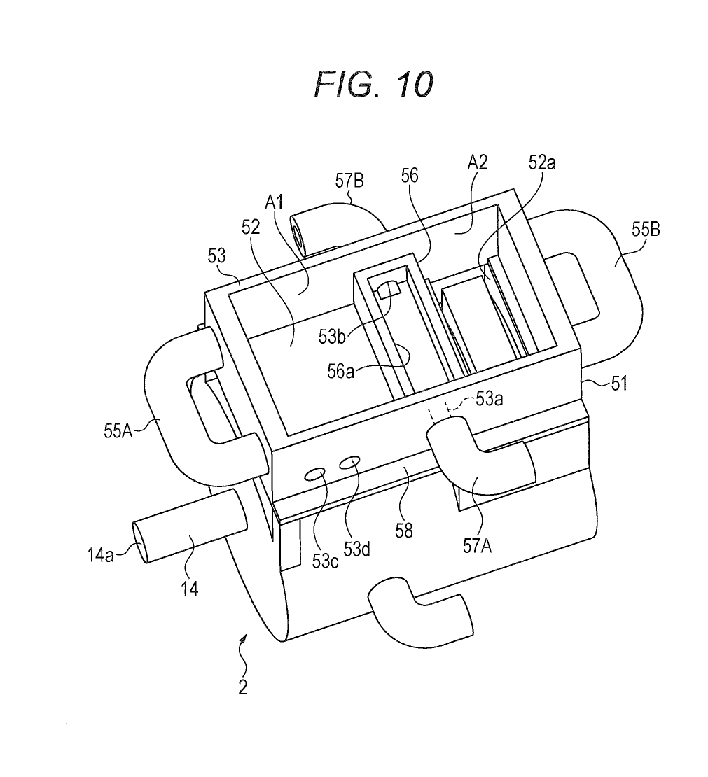

In the case body 51, a protuberance 56 is formed on the upper surface of the bottom portion 52 (see FIG. 10). The protuberance 56 extends along the width direction of the electric motor 2. Both ends of the protuberance 56 are connected to the inner surface of the peripheral wall 53. Accordingly, the inside of the case body 51 is divided into an area A1 at the side near the output terminal 14a and an area A2 at the side distant from the output terminal 14a.

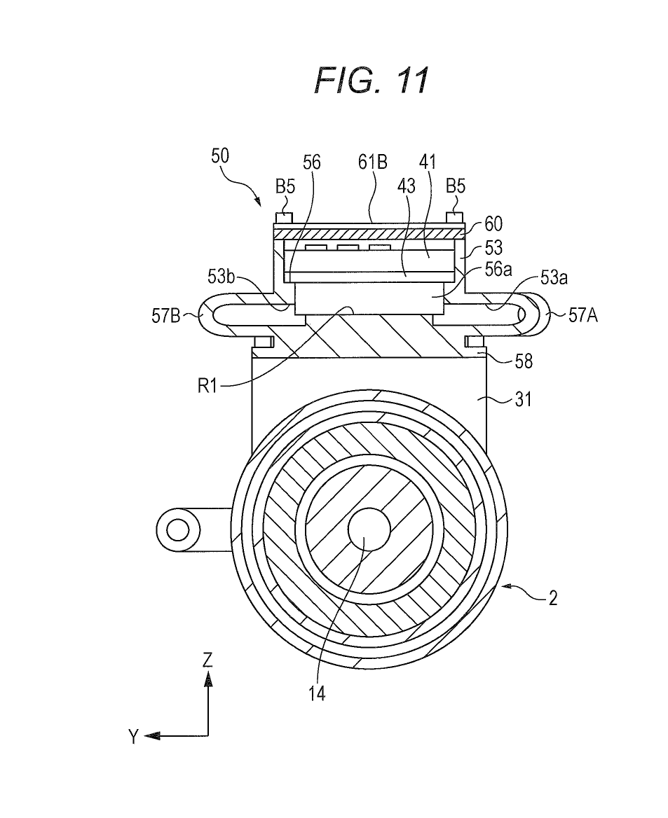

The protuberance 56 has a groove 56a in the upper surface along the width direction of the electric motor 2. The peripheral wall 53 has side holes 53a and 53b (see FIG. 11). The side holes 53a and 53b are connected to the both ends of the groove 56a and opened to the lateral direction of the peripheral wall 53 (for example, the width direction of the electric motor 2). The side holes 53a and 53b are opened to the pair of parallel surfaces along the longitudinal direction of the electric motor 2 on the outer periphery surface of the peripheral wall 53. The side holes 53a and 53b are positioned under the groove 56a. The opening directions of the side holes 53a and 53b are opposite to each other.

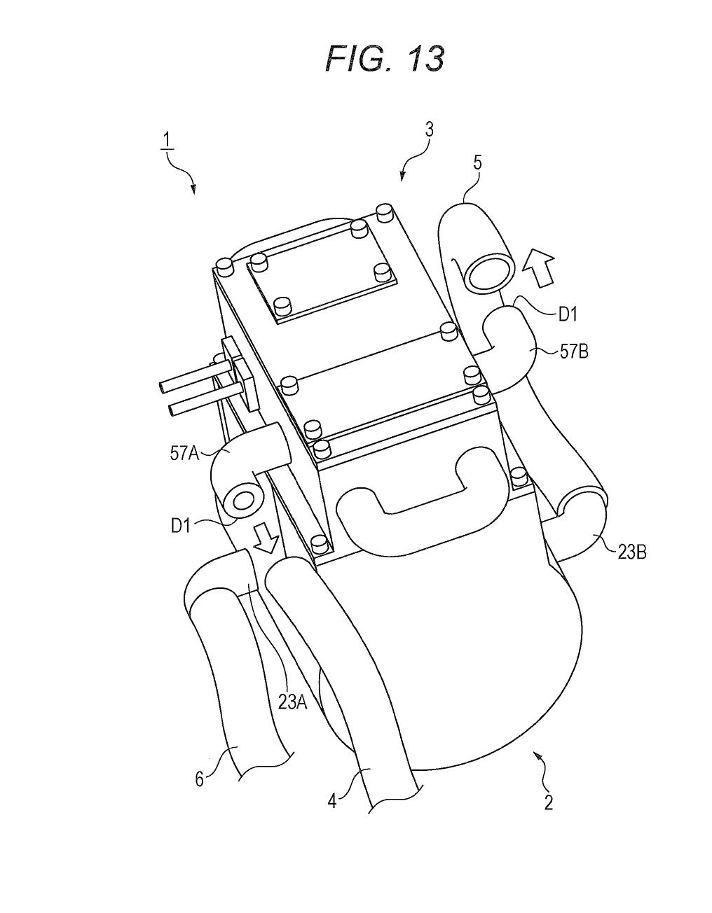

A joint pipe 57A protruding from the peripheral wall 53 to the lateral direction (for example, the width direction of the electric motor 2) is provided at the periphery edge of the side hole 53a. In addition, a joint pipe 57B protruding from the peripheral wall 53 to the lateral direction (for example, the width direction of the electric motor 2) is provided at the periphery edge of the side hole 53b. That is, the drive unit 1 further includes the pair of joint pipes 57A and 57B that protrudes from the circuit case 50 to the lateral direction (for example, the width direction of the electric motor 2) and is connected to the both ends of the flow passage R1. The pair of joint pipes 57A and 57B is bent to the lateral direction (for example, the longitudinal direction of the electric motor 2). Accordingly, open ends D1 (see FIGS. 3 and 13) of the joint pipes 57A and 57B are close to the peripheral wall 53. Further, the opening directions of the joint pipes 57A and 57B align with the outer periphery surface of the peripheral wall 53.

The bottom portion 52 has an opening 52a at a portion corresponding to an area A2. The opening 52a is positioned in correspondence with the connecting portion 31. The peripheral wall 53 has openings 53c and 53d in either one of a pair of wall portions along the longitudinal direction of the electric motor 2. The openings 53c and 53d are opened to an area A1 within the case body 51. The openings 53c and 53d accept the terminal 91P of the power cable 90P and the terminal 91N of the power cable 90N, respectively. That is, the drive unit 1 further includes the openings 53c and 53d as an example of openings (third openings) that are formed in the side portions of the circuit case 50 and accept the terminals 91P and 91N

As illustrated in FIGS. 4 and 11, the circuit board 41 is attached to the top of the protuberance 56 via the heat sink 43. The circuit board 41 and the heat sink 43 are fastened to the protuberance 56 from above by fastening members (not illustrated) such as bolts. In this state, the side holes 53a and 53b and the groove 56a are included in the flow passage R1 in contact with the heat sink 43 of the inverter 40 (see FIG. 11).

As illustrated in FIG. 2, the joint pipe 57A is connected to a supply source of a cooling liquid via a liquid supply hose 4. Accordingly, the cooling liquid passes through the flow passage R1. That is, the drive unit 1 further includes the flow passage R1 as an example of a first cooling flow passage that is provided, in contact with the inverter 40, in the circuit case 50 and lets the cooling liquid through. The cooling liquid is water, for example. The supply source of the cooling liquid is a radiator of the transport machine 9, for example.

As illustrated in FIGS. 4 and 11, the groove 56a serves as a heat absorber that extends in the direction crossing the vertical direction and contacts the inverter 40. The side hole 53a serves as a liquid supplier that guides the cooling liquid from the side portion of the circuit case 50 to the heat absorber. The side hole 53b serves as a liquid discharger that guides the cooling liquid from the heat absorber to the side portion of the circuit case 50.

As illustrated in FIG. 3, the joint pipe 57B is connected to the joint pipe 23B via a relay hose 5. Accordingly, the flow passage R1 and the flow passage R2 communicate with each other. As a result, the cooling liquid discharged from the flow passage R1 further passes through the flow passage R2. That is, the drive unit 1 further includes the flow passage R2 as an example of a second cooling flow passage that is provided in the electric motor 2 and communicates with the first cooling flow passage to let the cooling liquid through.

As illustrated in FIG. 2, the joint pipe 23A provided at the side opposite to the joint pipe 23B is connected to the supply source of the cooling liquid via a circulation hose 6. Accordingly, the cooling liquid circulates between the flow passages R1 and R2 and the supply source.

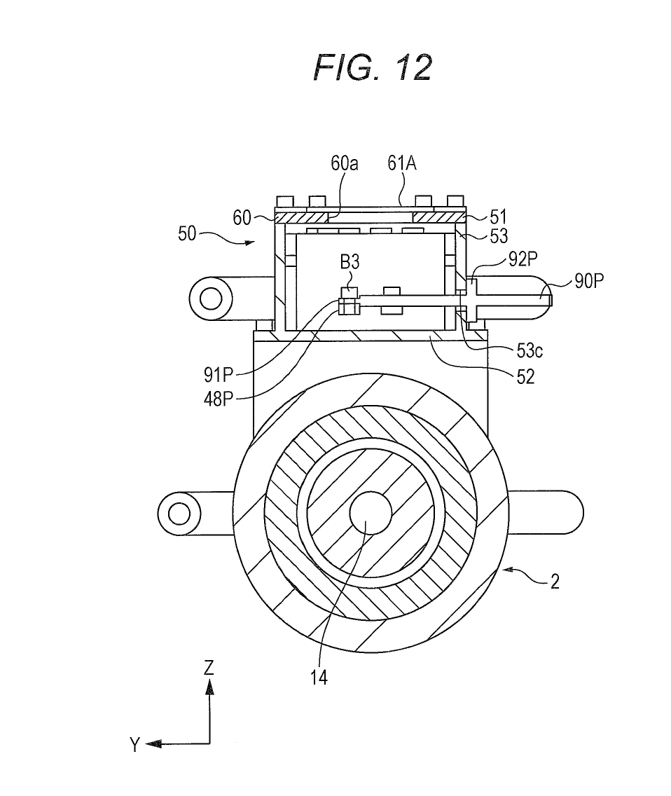

According to such piping, even in the state in which the circuit case 50 is installed on the electric motor 2, the ends of the joint pipes 57A and 57B can be opened by detaching the hoses 4 and 5 (see FIGS. 12 and 13). The joint pipes 57A and 57B protrude from the case body 51 to the lateral direction (for example, the width direction of the electric motor 2), and bend to the lateral direction (for example, the longitudinal direction of the electric motor 2). Accordingly, the opening direction of the joint pipes 57A and 57B are not oriented upward or downward in the vertical direction. Therefore, the both ends of the flow passage R1 are opened to the lateral direction of the circuit case 50 (for example, the longitudinal direction of the electric motor 2).

The connecting portion between the joint pipe 57A and the hose 4 and the connecting portion between the joint pipe 57B and the hose 5 serve such that, when the circuit case 50 is installed on the electric motor 2, the ends of the flow passage R1 (for example, the open ends D1 of the joint pipes 57A and 57B) are opened to the outside of the flow passage for cooling liquid. The ends of the flow passage R1 can be opened to the outside of the flow passage for cooling liquid by detaching the hoses 4 and 5 from the joint pipes 57A and 57B. Opening the ends of the flow passage R1 to the outside of the flow passage for cooling liquid includes bringing the ends of the flow passage R1 into the state in which the cooling liquid is discharged from the ends to the outside of the flow passage for cooling liquid, for example.

The open ends D1 of the joint pipes 57A and 57B (see FIG. 13) can be opened to the outside of the flow passage for cooling liquid when the circuit case 50 is installed on the electric motor 2. The open ends D1 of the joint pipes 57A and 57B can be opened to the outside of the flow passage for cooling liquid by detaching the hoses 4 and 5 from the joint pipes 57A and 57B, for example. That is, the drive unit 1 further includes the open end D1 that is provided at least at one end of the flow passage R1 in such a manner as to be capable of being opened to the outside of the flow passage for cooling liquid when the circuit case 50 is installed on the electric motor 2. Opening the open end D1 to the outside of the flow passage for cooling liquid includes bringing the open end D1 into the state in which the cooling liquid is discharged from the open end D1 to the outside of the flow passage for cooling liquid, for example.

The open ends D1 are provided at the ends of the joint pipes 57A and 57B. The open ends D1 open the flow passage R1 to the lateral direction of the circuit case 50 (for example, the longitudinal direction of the electric motor 2). Opening the flow passage R1 by the open ends D1 includes bringing the open ends D1 into the state in which the cooling liquid is discharged from the open ends D1 to the outside of the flow passage R1, for example. This state of the open ends D1 is realized by detaching the hoses 4 and 5 from the joint pipes 57A and 57B, for example. The phrase “the outside of the flow passage for cooling liquid” means the outside of the flow passage when the hoses 4 and 5 are connected to the joint pipes 57A and 57B, respectively.

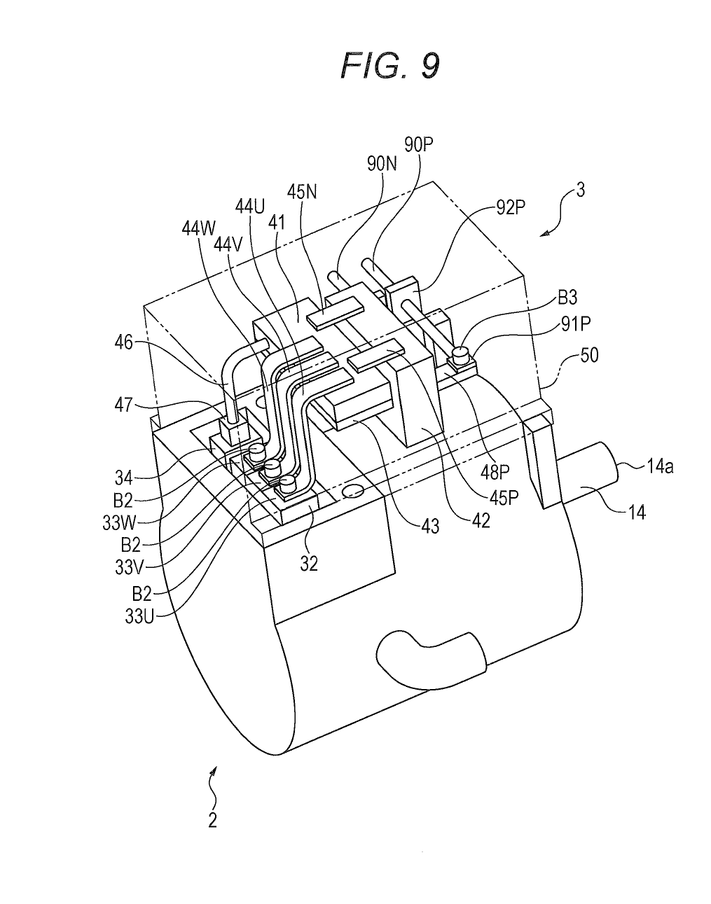

As illustrated in FIG. 9, the output terminals 44U, 44V, and 44W extending from the circuit board 41 are arranged on the input terminals 33U, 33V, and 33W via the opening 52a, respectively. The output terminals 44U, 44V, and 44W are fastened by bolts B2 from above to the input terminals 33U, 33V, and 33W respectively. That is, the drive unit 1 further includes the bolts B2 as an example of members fastening the output terminals 44U, 44V, and 44W of the inverter 40 from above to the input terminals 33U, 33V, and 33W of the electric motor 2.

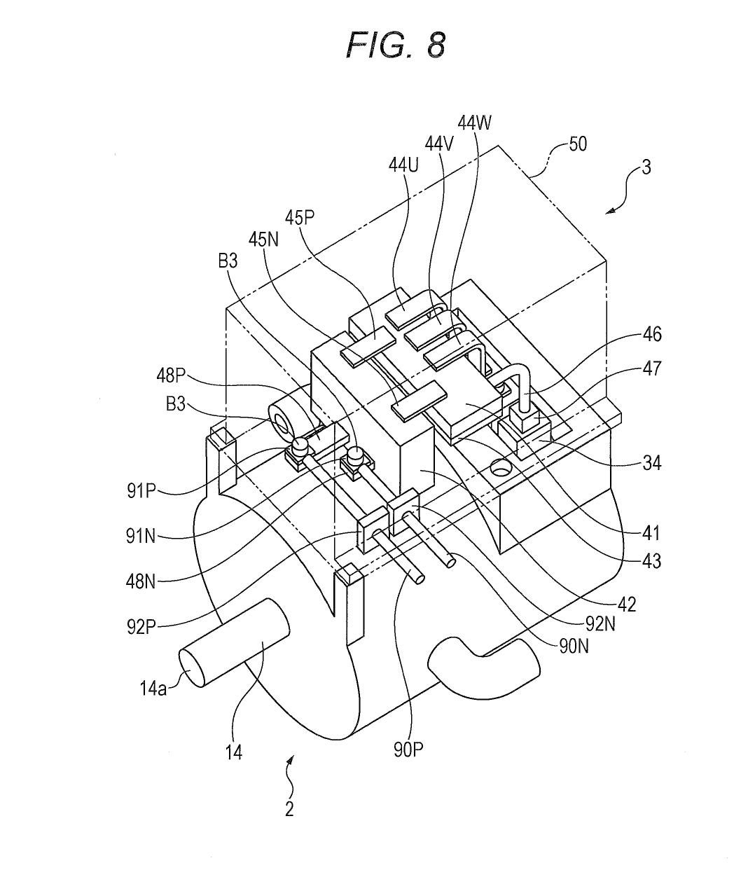

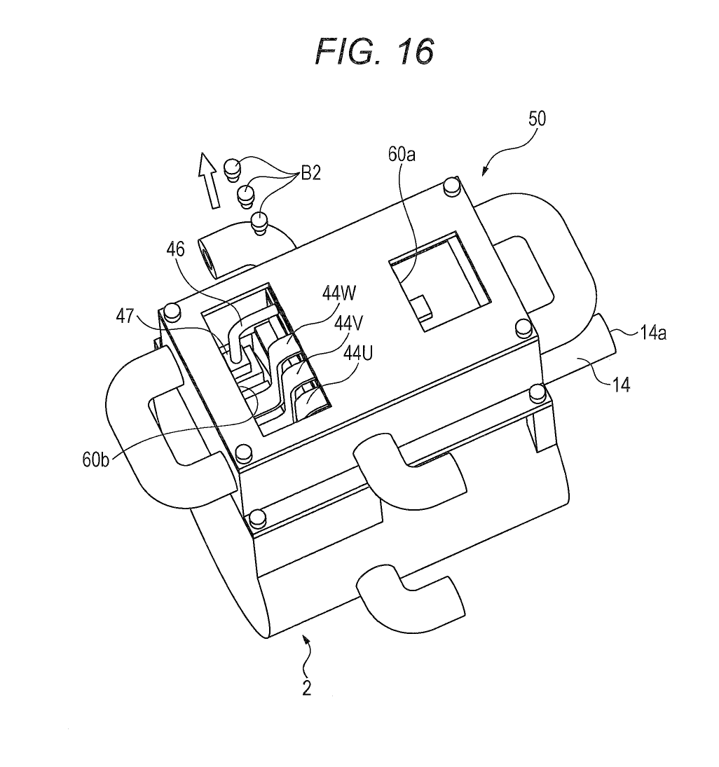

The signal connector 47 of the signal cable 46 extending from the circuit board 41 is connected to the signal connector 34 via the opening 52a (see FIGS. 8 and 16).

As illustrated in FIGS. 4 and 8, the smoothing capacitor 42 is housed in the area A1 of the case body 51. The smoothing capacitor 42 is arranged such that the input terminals 48P and 48N jut to the side opposite to the protuberance 56. The input terminals 48P and 48N jut from the smoothing capacitor 42 in different lengths. In the longitudinal direction of the electric motor 2, the positions of the tips of the input terminals 48P and 48N correspond to the positions of the openings 53c and 53d (see FIG. 10), for example.

The terminal 91P of the power cable 90P and the terminal 91N of the power cable 90N are introduced into the area A1 from the openings 53c and 53d, respectively (see FIG. 12). The terminals 91P and 91N introduced into the area A1 are arranged on the input terminals 48P and 48N, respectively. The terminals 91P and 91N are fastened by bolts B3 from above to the input terminals 48P and 48N, respectively. That is, the drive unit 1 further includes the bolts B3 as an example of members fastening the terminals 91P and 91N from above to the input terminals 48P and 48N.

As illustrated in FIG. 8, sealing members 92P and 92N are provided at the outer peripheries of the power cables 90P and 90N, respectively. The sealing members 92P and 92N are in contact with the outer surface of the peripheral wall 53 to seal the gap between the opening 53c and the power cable 90P and the gap between the opening 53d and the power cable 90N (also see FIG. 10). The sealing members 92P and 92N are fastened to the peripheral wall 53 by fastening members (not illustrated) such as bolts, for example, from the lateral direction (for example, the width direction of the electric motor 2).

As illustrated in FIGS. 2 to 4 and 14, the top plate 60 is arranged on the case body 51 and closes the upper part of the peripheral wall 53. The top plate 60 is fastened by bolts B4 to the peripheral wall 53 from above. The top plate 60 has openings 60a and 60b. The opening 60a is positioned above the connecting portions between the terminals 91P and 91N and the input terminals 48P and 48N. The opening 60b is positioned above the connecting portions between the output terminals 44U, 44V, and 44W and the input terminals 33U, 33V, and 33W. That is, the drive unit 1 further includes the opening 60a as an example of a first opening that is provided in the upper part of the circuit case 50 and opens the input terminals 48P and 48N of the inverter 40. The drive unit 1 further includes the opening 60b as an example of a second opening that is provided in the upper part of the circuit case 50 and opens the output terminals 44U, 44V, and 44W.

Covers 61A and 61B are arranged on the top plate 60 to cover the openings 60a and 60b, respectively. The covers 61A and 61B are fastened by bolts B5 to the top plate 60 from above. That is, the drive unit 1 further includes the covers 61A and 61B that cover the openings 60a and 60b, respectively. The drive unit 1 further includes the bolts B5 as an example of members fastening the covers 61A and 61B to the circuit case 50 from above.

### [Method for Replacing the Inverter]

Subsequently, the procedure for replacing the inverter unit 3 will be described. In general, the inverter is shorter in lifetime than an electric motor. Accordingly, it is assumed that there is the need for the drive unit 1 that the inverter unit 3 can be replaced while the electric motor 2 is mounted in the transport machine 9 to be driven. The procedure described above is a procedure for replacing the inverter unit 3 without having to remove the electric motor 2 from the transport machine 9 in accordance with this need.

### (Procedure for Removing the Inverter)

First, as illustrated in FIG. 13, the hoses 4 and 5 are detached from the joint pipes 57A and 57B to discharge the cooling liquid from the end of the joint pipe 57B. That is, the cooling liquid is discharged from the flow passage R1 as the first cooling flow passage. At that time, the discharge of the cooling liquid can be facilitated by pressurization from the joint pipe 57A side or suction from the joint pipe 57B side. The cooling liquid may be discharged from the end of the joint pipe 57A. In this case, the discharge of the cooling liquid can be facilitated by pressurization from the joint pipe 57B side or suction from the joint pipe 57A side.

Alternatively, instead of detaching the hose 5 from the joint pipe 57B, the hose 4 may be detached from the joint pipe 57A and the drain plug 24 be detached from the drain hole 21d of the motor case 20 to discharge the cooling liquid from the drain hole 21d. That is, out of the both ends of the flow passage R1, the end opposite to the end connected to the flow passage R2 may be opened to discharge the cooling liquid from the flow passage R1 through the drain hole 21d of the flow passage R2. After that, the hose 5 may be detached from the joint pipe 57B to further discharge the cooling liquid left in the flow passage R1 from either of the ends of the joint pipes 57A and 57B.

Alternatively, instead of detaching the hoses 4 and 5 from the joint pipes 57A and 57B, the drain plug 24 may be detached from the drain hole 21d to discharge the cooling liquid from the drain hole 21d. Further, after that, the hoses 4 and 5 may be detached from the joint pipes 57A and 57B, respectively, to discharge the cooling liquid left in the flow passage R1 from either of the ends of the joint pipes 57A and 57B.

As described above, the groove 56a aligns with the width direction of the electric motor 2. The side holes 53a and 53b are opened in the lateral direction of the circuit case 50 (for example, the width direction of the electric motor 2). Accordingly, in any of the discharge methods, the cooling liquid is discharged from the flow passage R1 along the direction crossing the vertical direction.

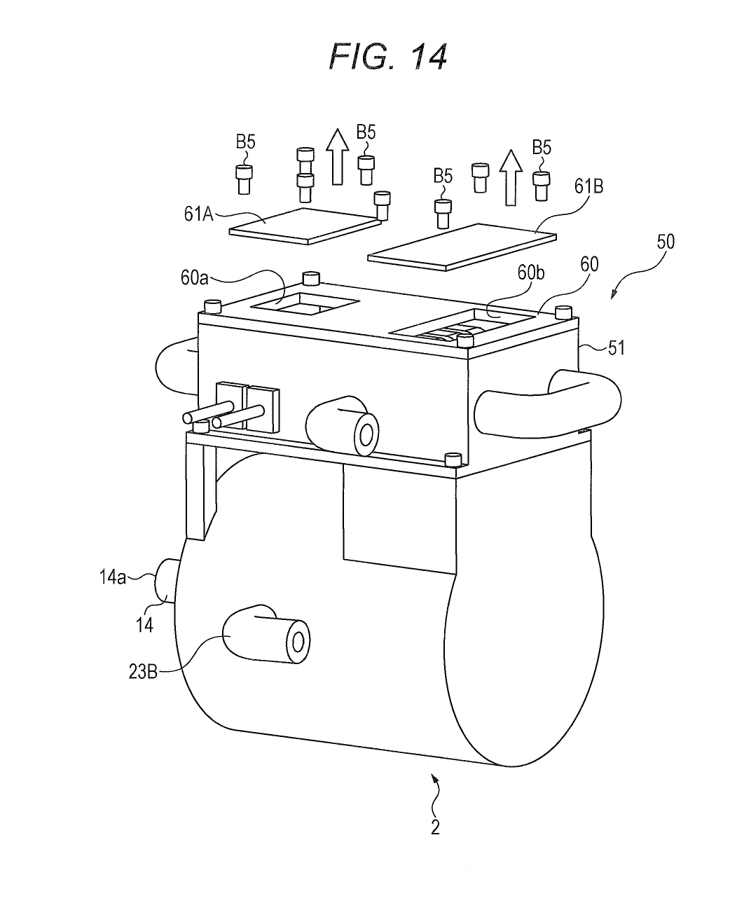

Next, as illustrated in FIG. 14, the bolts B5 fastening the covers 61A and 61B to the top plate 60 are removed upward, and the covers 61A and 61B are removed from the top plate 60. Accordingly, the openings 60a and 60b are opened.

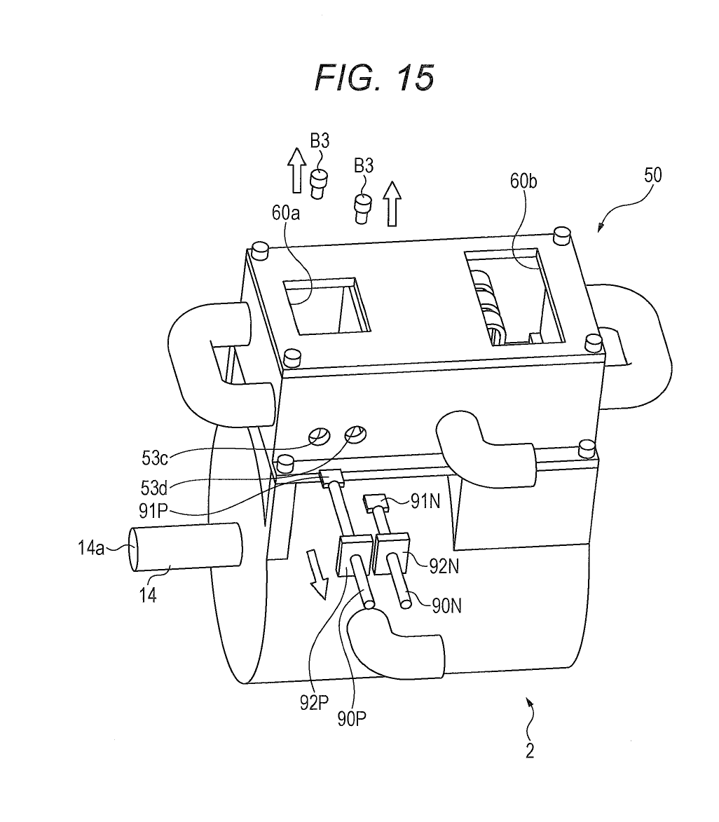

Next, the electric system formed by the inverter 40 is removed. Specifically, as illustrated in FIG. 15, the bolts B3 fastening the terminal 91P of the power cable 90P and the terminal 91N of the power cable 90N to the input terminals 48P and 48N are removed upward, and the terminals 91P and 91N are extracted from the circuit board 41. Accordingly, the terminals 91P and 91N are removed from the input terminals 48P and 48N. After that, as illustrated in FIG. 16, the bolts B2 fastening the output terminals 44U, 44V, and 44W to the input terminals 33U, 33V, and 33W are removed upward. Accordingly, the output terminals 44U, 44V, and 44W are removed from the input terminals 33U, 33V, and 33W. Further, the signal connector 47 is removed upward from the signal connector 34.

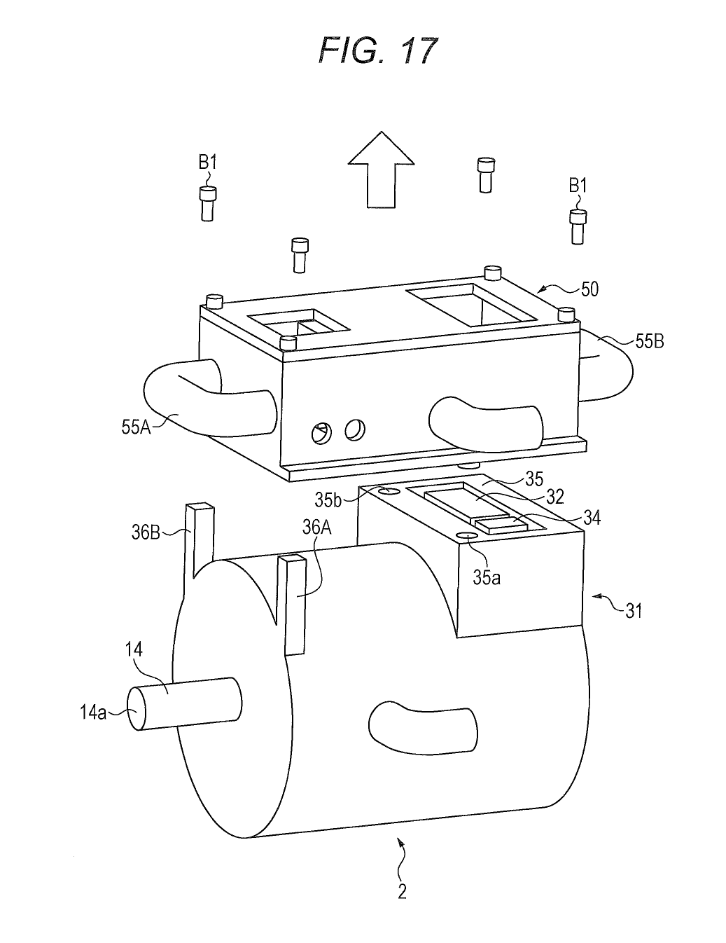

Next, as illustrated in FIG. 17, the bolts B1 fastening the circuit case 50 to the electric motor 2 are removed upward to detach the circuit case 50 from the electric motor 2. At that time, the handles 55A and 55B may be gripped to carry the circuit case 50.

### (Procedure for Installing the Inverter)

The inverter unit 3 is installed by following the procedure for removal in reverse. First, the inverter unit 3 is placed on the electric motor 2 fixed to the transport machine 9 (see FIG. 17). At that time, the positioning protrusions 54A and 54B are attached to the positioning holes 35a and 35b. Accordingly, the inverter unit 3 is correctly positioned. After that, the circuit case 50 is fastened by the bolt B1 to the electric motor 2 from above.

Next, the electric system in the inverter 40 is connected. Specifically, the signal connector 47 is first connected to the signal connector 34 from above. Then, the output terminals 44U, 44V, and 44W are fastened by the bolts B2 from above to the input terminals 33U, 33V, and 33W. Accordingly, the output terminals 44U, 44V, and 44W are connected to the input terminals 33U, 33V, and 33W (see FIG. 16). After that, the terminals 91P and 91N are inserted into the area A1 through the openings 53c and 53d. The terminals 91P and 91N are fastened by the bolts B3 from above to the input terminals 48P and 48N. Accordingly, the terminals 91P and 91N are connected to the input terminals 48P and 48N (see FIG. 15).

Next, the covers 61A and 61B are arranged to cover the openings 60a and 60b, respectively. Then, the covers 61A and 61B are fastened by the bolts B5 to the top plate 60 from above (see FIG. 14).

Next, the hose 5 is connected to the joint pipe 57B, and the hose 4 is connected to the joint pipe 57A (see FIG. 13). After that, the cooling liquid is passed through the flow passages R1 and R2. As described above, the groove 56a aligns with the width direction of the electric motor 2, and the side holes 53a and 53b are opened in the lateral direction of the circuit case 50 (for example, the width direction of the electric motor 2). Accordingly, the cooling liquid is passed through the flow passage R1 in the direction crossing the vertical direction. Accordingly, the replacement of the inverter unit 3 is completed.

[Advantageous Effects of this Embodiment]

As described above, the drive unit 1 includes the electric motor 2, the circuit case 50 that houses the inverter 40 and is installed on the electric motor 2, the flow passage R1 that is provided, in contact with the inverter 40, in the circuit case 50 and lets the cooling liquid through, the flow passage R2 that is provided in the electric motor 2 and lets the cooling liquid through in communication with the flow passage R1, and the open end D1 that is provided on at least one end side of the flow passage R1 so as to be capable of being opened to the outside of the flow passage for cooling liquid when the circuit case 50 is installed on the electric motor 2

According to this configuration, when the circuit case 50 is installed on the electric motor 2, the liquid can be drained from the flow passage R1. Accordingly, the electric system can be removed when the cooling liquid is drained from the flow passage R1. Therefore, the inverter 40 can be easily replaced.

The circuit case 50 may be installed on the electric motor 2 from above. In addition, the open ends D1 may open the flow passage R1 in the lateral direction of the circuit case 50 (for example, the longitudinal direction of the electric motor 2). In this case, the liquid can be drained from the flow passage R1 in the direction crossing the alignment direction of the circuit case 50 and the electric motor 2. Accordingly, it is possible to suppress liquid dripping into the connecting portion between the circuit case 50 and the electric motor 2 in a more reliable manner. Therefore, the inverter 40 can be replaced more easily.

The flow passage R1 may have the heat absorber (groove 56a) that extends in the direction crossing the vertical direction in contact with the inverter 40, the liquid supplier (side hole 53a) that guides the cooling liquid from the side portion of the circuit case 50 to the heat absorber, and the liquid discharger (side hole 53b) that guides the cooling liquid from the heat absorber to the side portion of the circuit case 50. The liquid supplier and the liquid discharger may be positioned under the heat absorber. In this case, the cooling liquid can be discharged more easily prior to the removal of the electric system. Therefore, the inverter 40 can be replaced more easily.

The drive unit 1 may further include the pair of joint pipes 57A and 57B that protrude from the circuit case 50 in the lateral direction (for example, the width direction of the electric motor 2) and connect to the both ends of the flow passage R1. The open end D1 may be provided at one end of at least one of the pair of joint pipes 57A and 57B. In this case, by providing the open ends D1 at the ends of the joint pipes 57A and 57B protruding in the lateral direction, it is possible to suppress more reliably liquid dripping into the connecting portion between the circuit case 50 and the electric motor 2. Therefore, the inverter 40 can be replaced more easily.

The pair of joint pipes 57A and 57B may be bent in the lateral direction (for example, the longitudinal direction of the electric motor 2). In this case, the hose arrangement can be shifted toward the circuit case 50 and the electric motor 2. As a result, it is possible to achieve space saving. In addition, it is possible to suppress liquid dripping into the connecting portion between the inverter 40 and the electric motor 2 more reliably as compared to the case where the joint pipes 57A and 57B are bent immediately below. Therefore, the inverter 40 can be replaced more easily.

The drive unit 1 may further include the members (bolts B1) that fasten the circuit case 50 to the electric motor 2 from above, the first opening (opening 60a) that is provided in the upper part of the circuit case 50 and opens the input terminals 48P and 48N of the inverter 40, the members (bolts B3) that fasten the terminal 91P of the power cable 90P and the terminal 91N of the power cable 90N to the input terminals 48P and 48N of the inverter 40 from above, the first cover (cover 61A) that covers the first opening, the second opening (opening 60b) that is provided in the upper part of the circuit case 50 and opens the output terminals 44U, 44V, and 44W of the inverter 40, the members (bolts B2) that fasten the output terminals 44U, 44V, and 44W of the inverter 40 to the input terminals 33U, 33V, and 33W of the electric motor 2 from above, and the second cover (cover 61B) that covers the second opening.

In this case, the direction of discharging the cooling liquid crosses the direction of removing the electric system and the mechanical system. Accordingly, it is possible to suppress more reliably liquid dripping into the connecting portion in the electric system and the connecting portion in the mechanical system. In addition, by covering with a cover the opening for opening upward the connecting portion in the electric system, it is possible to suppress more reliably liquid dripping into the connecting portion in the electric system. Therefore, the inverter 40 can be replaced more easily.

The drive unit 1 may further include the third openings (openings 53c and 53d) that are provided in the side portions of the circuit case 50 and accepts the terminal 91P of the power cable 90P and the terminal 91N of the power cable 90N. In this case, by passing the power cables 90P and 90N through the third openings, it is possible to seal the opening 60a with the cover 61A in a more secure manner. Accordingly, it is possible to suppress more reliably liquid dripping into the connecting portion in the electric system. Therefore, the inverter 40 can be replaced more easily.

The drive unit 1 may further include the first attachment portion (positioning holes 35a and 35b) that is provided in the upper part of the electric motor 2 and the second attachment portion (positioning protrusions 54A and 54B) that is provided on the lower part of the circuit case 50 and attached into the first attachment portion from above. In this case, even when the electric motor 2 is mounted in the transport machine 9 to be driven, the electric motor 2 and the circuit case 50 can be easily positioned. Therefore, the inverter 40 can be replaced more easily.

The drive unit 1 may further include the grip handles 55A and 55B provided at the outside of the circuit case 50. In this case, the circuit case 50 can be easily removed and re-arranged. Therefore, the inverter 40 can be replaced more easily.

The procedure for removing the inverter unit 3 in the drive unit 1 includes: (A) discharging the cooling liquid from the flow passage R1 when the electric motor 2 is fixed to the transport machine 9; (B) after the discharging (A) of the cooling liquid, removing the electric system in the inverter 40; and (C) after the removing (B) of the electric system, removing the circuit case 50 from the electric motor 2.

According to this procedure, it is possible to remove the electric system when the cooling liquid is drained from the flow passage R1. In addition, it is possible to remove the mechanical system when the electric system is removed. Therefore, even when the electric motor 2 is mounted in the transport machine 9, the inverter 40 can be easily replaced.

During the removing (B) of the electric system, after the removal of the terminal 91P of the power cable 90P and the terminal 91N of the power cable 90N from the input terminals 48P and 48N of the inverter 40, the output terminals 44U, 44V, and 44W of the inverter 40 may be removed from the input terminals of the electric motor 2. In this case, when the power supply is shut off, the output terminals 44U, 44V, and 44W of the inverter 40 can be removed from the input terminals 33U, 33V, and 33W of the electric motor 2. Therefore, the inverter 40 can be replaced more easily.

During the discharging (A) of the cooling liquid, the cooling liquid may be discharged from the flow passage R1 in the direction crossing the vertical direction. During the removing (B) of the electric system, the members (bolts B3) fastening the terminal 91P of the power cable 90P and the terminal 91N of the power cable 90N to the input terminals 48P and 48N of the inverter 40 and the members (bolts B3) fastening the output terminals 44U, 44V, and 44W of the inverter 40 to the input terminals 33U, 33V, and 33W of the electric motor 2 may be removed upward. During the removing (C) of the circuit case 50, the members (bolts B1) fastening the circuit case 50 to the electric motor 2 may be removed upward. In this case, the direction of discharging the cooling liquid crosses the direction of removing the electric system and the mechanical system. Accordingly, it is possible to suppress more reliably liquid dripping into the connecting portion in the electric system and the connecting portion in the mechanical system. Therefore, the inverter 40 can be replaced more easily.

During the discharging (A) of the cooling liquid, the cooling liquid may be discharged from the flow passage R1 by at least either of pressurization and suction. In this case, the cooling liquid can be discharged more reliably prior to the removal of the electric system. Accordingly, it is possible to suppress more reliably liquid dripping into the connecting portion in the electric system. Therefore, the inverter 40 can be replaced more easily.

The procedure for attaching the inverter unit 3 to the electric motor 2 includes: (a) attaching the circuit case 50 to the electric motor 2 fixed to the transport machine 9; (b) after the attaching (a) of the circuit case 50, connecting the electric system to the inverter 40; (c) after the connecting (b) of the electric system, passing the cooling liquid through the flow passage R1.

According to this procedure, the electric system can be connected when the circuit case 50 is definitely positioned relative to the electric motor 2 by the connection of the mechanical system. By connecting the electric system prior to the passage of the cooling liquid, the electric system can be connected in the absence of the cooling liquid. Accordingly, the inverter 40 can be easily replaced even when the electric motor 2 is mounted in the transport machine 9.

During the connecting (b) of the electric system, after the connection of the output terminals 44U, 44V, and 44W of the inverter 40 to the input terminals 33U, 33V, and 33W of the electric motor 2, the terminal 91P of the power cable 90P and the terminal 91N of the power cable 90N may be connected to the input terminals 48P and 48N of the inverter 40. In this case, when the power supply is shut off, the output terminals 44U, 44V, and 44W of the inverter 40 can be connected to the input terminals 33U, 33V, and 33W of the electric motor 2. Therefore, the inverter 40 can be replaced more easily.

During the attaching (a) of the circuit case 50, the circuit case 50 may be fastened to the electric motor 2 from above. During the connecting (b) of the electric system, the output terminals 44U, 44V, and 44W of the inverter 40 may be fastened from above to the input terminals 33U, 33V, and 33W of the electric motor 2. Further, during the connecting (b) of the electric system, the terminal 91P of the power cable 90P and the terminal 91N of the power cable 90N may be fastened from above to the input terminals 48P and 48N of the inverter 40. During the passing (c) of the cooling liquid, the cooling liquid may be passed through the flow passage R1 along the direction crossing the vertical direction. In this case, the direction of passing the cooling liquid crosses the direction of connecting the electric system and the mechanical system. Accordingly, it is possible to suppress more reliably liquid dripping into the connecting portion in the electric system and the connecting portion in the mechanical system. Therefore, the inverter 40 can be replaced more easily.

The embodiment has been described so far. The technique of the present disclosure is not limited to the foregoing embodiment. The technique of the present disclosure can be modified in various manners without deviating from the gist of the present disclosure. The first attachment portion and the second attachment portion are not limited to the foregoing ones (the positioning protrusions 54A and 54B and the positioning holes 35a and 35b). For example, the positioning holes may be provided on the circuit case 50 side, and the positioning protrusions to be attached to the positioning holes may be provided on the electric motor 2 side. The various fastening members are not limited to the bolts described above as examples. The various fastening members may be press-fit pins, for example.

The foregoing detailed description has been presented for the purposes of illustration and description. Many modifications and variations are possible in light of the above teaching. It is not intended to be exhaustive or to limit the subject matter described herein to the precise form disclosed. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims appended hereto.

What is claimed is:

1. A drive unit comprising:
an electric motor;
a circuit case that houses an inverter therein and is installed on the electric motor;
a first cooling flow passage that is provided, in contact with the inverter, in the circuit case and lets a cooling liquid flow therethrough;
a second cooling flow passage that is provided in the electric motor and lets the cooling liquid flow therethrough in communication with the first cooling flow passage; and
an open end that is provided on at least one end side of the first cooling flow passage so as to be capable of being opened to the outside of the flow passage for the cooling liquid when the circuit case is installed on the electric motor.

2. The drive unit according to claim 1, wherein
the circuit case is configured to be installed on the electric motor from above, and
the open end is configured to open the first cooling flow passage to a lateral direction of the circuit case.

3. The drive unit according to claim 2, wherein
the first cooling flow passage has:
a heat absorber that extends in a direction crossing the vertical direction and is in contact with the inverter;
a liquid supplier that guides the cooling liquid from a side portion of the circuit case to the heat absorber; and
a liquid discharger that guides the cooling liquid from the heat absorber to the side portion of the circuit case, and
the liquid supplier and the liquid discharger are positioned under the heat absorber.

4. The drive unit according to claim 2, further comprising
a pair of joint pipes that protrudes from the circuit case to the lateral direction and is connected to both ends of the first cooling flow passage, wherein
the open end is provided at an end of at least one of the pair of joint pipes.

5. The drive unit according to claim 4, wherein
the pair of joint pipes is bent in the lateral direction.

6. The drive unit according to claim 2, further comprising:
a member that fastens the circuit case to the electric motor from above;
a first opening that is provided in an upper part of the circuit case and opens an input terminal of the inverter;
a member that fastens a terminal of a power cable to the input terminal of the inverter from above;
a first cover that covers the first opening;
a second opening that is provided in the upper part of the circuit case and opens an output terminal of the inverter;
a member that fastens the output terminal of the inverter to an input terminal of the electric motor from above; and
a second cover that covers the second opening.

7. The drive unit according to claim 6, further comprising
a third opening that is provided in an side portion of the circuit case and accepts the terminal of the power cable.

8. The drive unit according to claim 1, further comprising:
a first attachment portion that is provided in an upper part of the electric motor; and
a second attachment portion that is provided on a lower part of the circuit case and attached to the first attachment portion from above.

9. The drive unit according to claim 1, further comprising
a grip handle provided at the outside of the circuit case.

10. A method for removing an inverter, comprising:
(A) in a drive unit including an electric motor fixed to a transport machine and a circuit case that houses an inverter and is installed on the electric motor from above, discharging a cooling liquid from a cooling flow passage provided, in contact with the inverter, in the circuit case;
(B) after the discharging (A) of the cooling liquid, removing an electric system in the inverter; and
(C) after the removing (B) of the electric system, removing the circuit case from the electric motor.

11. The method for removing an inverter according to claim 10, wherein
during the removing (B) of the electric system, after the removal of a terminal of a power cable from an input terminal of the inverter, an output terminal of the inverter is removed from an input terminal of the electric motor.

12. The method for removing an inverter according to claim 11, wherein
during the discharging (A) of the cooling liquid, the cooling liquid is discharged from the cooling flow passage along a direction crossing the vertical direction,
during the removing (B) of the electric system, a member fastening the terminal of the power cable to the input terminal of the inverter and a member fastening the output terminal of the inverter to the input terminal of the electric motor are removed upward, and
during the removing (C) of the circuit case, a member fastening the circuit case to the electric motor is removed upward.

13. The method for removing an inverter according to claim 10, wherein
during the discharging (A) of the cooling liquid, the cooling liquid is discharged from the cooling flow passage by at least one of pressurization and suction.

14. A method for installing an inverter, comprising:
(a) installing a circuit case housing an inverter to an electric motor fixed to a transport machine;
(b) after the installing (a) of the circuit case, connecting an electric system to the inverter; and
(c) after the connecting (b) of the electric system, passing a cooling liquid through a cooling flow passage provided, in contact with the inverter, in the circuit case.

15. The method for installing an inverter according to claim 14, wherein
during the connecting (b) of the electric system, after connecting an output terminal of the inverter to an input terminal of the electric motor, a terminal of a power cable is connected to an input terminal of the inverter.

16. The method for installing an inverter according to claim 15, wherein
during the installing (a) of the circuit case, the circuit case is fastened to the electric motor from above,
during the connecting (b) of the electric system, the output terminal of the inverter is fastened to the input terminal of the electric motor from above, and the terminal of the power cable is fastened to the input terminal of the inverter from above, and
during the passing (c) of the cooling liquid, the cooling liquid is passed through the cooling flow passage along a direction crossing the vertical direction.
